(19) United States
(12) Patent Application Publication
(10) Pub. No.: US 2006/0209345 A1
(43) Pub. Date: Sep. 21, 2006

(54) Printing systems and methods for inserts

(75) Inventors: Roman Liccini, Los Angeles, CA (US); William Samuel Jacobs, Los Angeles, CA (US); John Gil-Gomez, Rancho Palos Verdes, CA (US)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(73) Assignee: Xerox Corporation

(21) Appl. No.: 11/082,421

(22) Filed: Mar. 17, 2005

(51) Int. Cl. G06K 15/00

(52) U.S. Cl. 358/1.16; 358/1.14

(57) ABSTRACT

A printing system includes a bypass path that transports printing media around a marking system such that the printing media can avoid the marking system and not be affected by the marking system. A memory device associates “non-printing media route information” with one or more corresponding storage units when printing media that should avoid the marking system is loaded into the one or more corresponding storage units. The non-printing media that should avoid the marking system may damage the marking system and/or may be damaged by the marking system. Therefore, the controller prevents printing instructions from being executed that direct the printing media into the marking system from one or more of the storage units with which the non-printing media route information is associated in the memory device.

### BACKGROUND AND SUMMARY

Embodiments herein generally comprise a printing system that has the ability to collate non-printing inserts into a print job. Cut-sheet printers with multiple paper trays enable incorporation of both blank and preprinted pages into print jobs. In printers, preprinted pages can be placed in an interposer or direct insert tray. These trays bypass the marking process, and are frequently used to insert color pages into monochromatic documents. A print job's ticket selects the direct insert stock to be inserted, where it is to be inserted, and how many sheets are to be inserted. Unfortunately, such insertions are error prone. Printer operators can experience two types of accidents with direct inserts (or preprinted stocks). On printers with trays that are not configurable, operators can accidentally place direct inserts in “printing” trays. On printers with trays that can be configured as printing or non-printing, they can forget to set the drawer to be a “non-printing” drawer. For example, in the case of xerographic printers, blank inserts may pass safely through the fuser, but direct inserts cannot because the heat of the fuser can damage the preprinted inserts or the fuser itself. Hence, treating a blank insert like a direct insert is harmless, but the reverse is not the case. When a cut-sheet printer with multiple trays receives a job containing inserts, operators were conventionally required to first disambiguate whether the inserts were blank inserts or direct inserts and then load the stock into the correct paper tray and/or identify the paper tray as a non-printing tray.

The cost of either error is high, because the direct inserts can be ruined, the printed sheets can be wasted, and in some cases, so much color is transferred from the direct inserts to the fuser roll that a technician must service the printer. This embodiments described here are designed to prevent such errors.

More specifically, embodiments herein comprise a printing system that includes storage units, each of which can store one or more different types of printing media, such as different sized cut sheets of paper, transparencies, card stock, and similar media. A transportation system of belts, rollers, nips, and other media handlers is used to transport the printing media to a marking system, such as a toner applier, fuser, ink jet, and other similar marking devices that allow the marking system to print on the printing media. The printing system also includes a bypass path that transports the printing media around the marking system such that the printing media avoids the marking system and is not affected by (and does not affect) the marking system. A controller is used to direct the printing media into either the marking system or the bypass path. A sorter is used to sort and combine the sheets of the printing media that are output from the marking system and from the bypass path.

A memory device is connected to the controller. The memory device associates a “non-printing media route information” with one or more corresponding storage units when printing media that should avoid the marking system is loaded into the corresponding storage units. The non-printing media that should avoid the marking system may damage the marking system and/or may be damaged by the marking system. Therefore, the controller prevents printing instructions from being executed that direct the printing media into the marking system from one or more of the storage units with which the media route information is associated in the memory device. If a print job requests media whose route information does not match the media loaded in the printer, the user interface indicates to the user that the printing instructions were not executed and explains that this relates to an inconsistency between the print job's media route information and the printer's media route information.

As the printing media is loaded into the storage units, the user associates the media route information with one or more corresponding storage units via the user interface. The printing instructions include printing media route information indicating whether the printing media will be directed to the marking system. The controller includes a comparator to compare the printing instructions with the printer's media route information in the memory device to determine whether the printing instructions are attempting to direct the printing media into the marking system from one or more of the storage units where non-printing media route information has been associated.

These and other features are described in, or are apparent from, the following detailed description.

### BRIEF DESCRIPTION OF THE DRAWINGS

Various exemplary embodiments of the systems and methods described in detail below, with reference to the attached drawing figures, in which:

FIG. 1 is a schematic representation of a printing system;

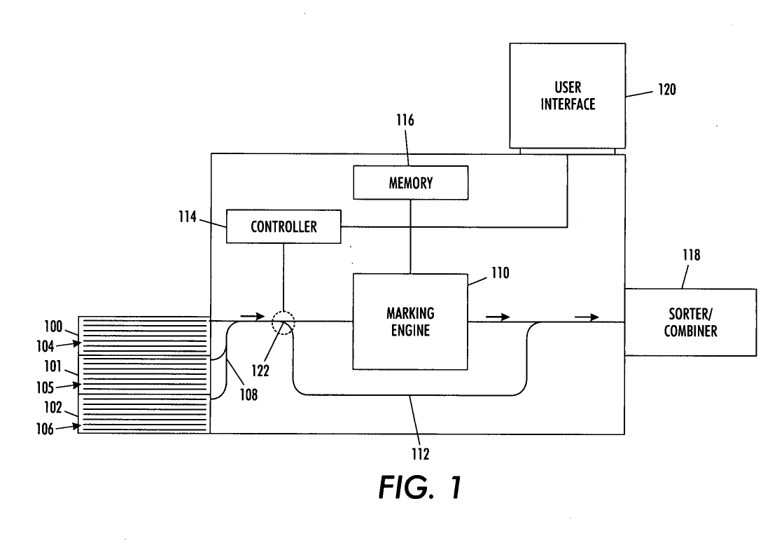

FIG. 2 is a schematic representation of a portion of a graphic user interface;

FIG. 3 is a schematic representation of a portion of a graphic user interface; and

FIG. 4 is a flow chart illustrating one embodiment of the invention.

### DETAILED DESCRIPTION

As mentioned above, the cost of direct insert errors are high, because the direct inserts can be ruined, the printed sheets can be wasted, and in some cases, color is undesirably transferred to the fuser roll. Thus, embodiments here provide, among other features, a new paper stock attribute adapted to distinguish between printing and non-printing stocks. Only printing stocks (determined according to the attribute) can be sent through the marking device and non-printing stocks (again, determined according to the attribute) must bypass the marking device.

When paper is placed in a paper tray, the operator/user must specify whether the tray contains non-printing or printing media. This can be implemented with a pair of radio buttons, a checkbox, or any other user interface mechanism used to represent a boolean choice to the user. Because the tray's media is defined, this information can now be specified as part of queue definition and job ticketing to avert such problems with mishandled direct inserts. In particular, a printing system with a job ticket that explicitly requests direct insert stocks as non-printing stocks is described herein. If the job requests a non-printing stock, but the requested stock is in a printing (fuser) tray, the printer will not allow the job to print. If the job requests a printing stock, but the requested stock is in a non-printing (non-fuser) tray, the printer will not allow the job to print. Thus, embodiments herein classify the paper stocks in a job ticket as printing or non-printing stocks (fuser or non-fuser) during print submission, which enables conflict checking between the media requested in the job ticket and the media in the tray at the printer itself.

More specifically, embodiments herein comprise a printing system that includes storage units 100-102, each of which can store one or more different types of printing media 104-106, such as different sized cut sheets of paper, transparencies, card stock, and similar media. A transportation system 108 of belts, rollers, nips, and other media handlers is used to transport the printing media 104-106 to a marking system 110, such as a toner applier, fuser, ink jet, and other similar marking devices that allow the marking system 110 to print on the printing media 104-106. The details of such a marking engine are disclosed in U.S. Pat. No. 5,489,969, the full disclosure of which is incorporated herein by reference.

The printing system also includes a bypass path 112 that transports the printing media 104-106 around the marking system 110 such that the printing media 104-106 avoids the marking system 110 and is not affected by and does not affect the marking system 110. A controller 114 is used to direct the printing media 104-106 into either the marking system 110 or the bypass path 112 by controlling a paper guide/paper path valve 122. A sorter 118 is used to sort and combine the sheets of the printing media 104-106 that are output from the marking system 110 and from the bypass path 112.

A memory device 116 is connected to the controller 114. The memory device 116 associates media route information with one or more corresponding storage units 100-102. When printing media 104-106 that should avoid the marking system 110 is loaded into the corresponding storage units 100-102, the route information is set “Non-printing.” This protects non-printing media that should avoid the marking system 110, may damage the marking system 110, and/or may be damaged by the marking system 110. Therefore, the controller 114 prevents printing instructions from being executed that direct media into the marking system 110 from one or more of the storage units 100-102 with which the non-printing media indicator is enabled in the memory device 116. If this occurs, the user interface 120 indicates to the user that the printing instructions were not executed and explains that this relates to an inconsistency between the non-printing media route information and media route information in the print job that requires the printing media be directed to the marking system 110.

As the printing media 104-106 is loaded into the storage units 100-102, the user interface 120 is used to associate the non-printing media route information with one or more corresponding storage units 100-102. The printing instructions include printing media route information indicating whether the printing media will be directed to the marking system 110. The controller 114 includes a comparator to compare the printing instructions with the non-printing media 104-106 indicator in the memory device 116 to determine whether the printing instructions are attempting to direct the printing media 104-106 into the marking system 110 from one or more of the storage units 100-102 with which the non-printing media 104-106 indicator has been associated.

Thus, embodiments herein include a new media attribute that is transferred from the print client to a cut-sheet printer with multiple trays during job submission. The inserts may be blank inserts (i.e., non-billable sheets that pass through the marking engine, but are not marked) or direct inserts (i.e., non-billable sheets that cannot pass through the marking engine.

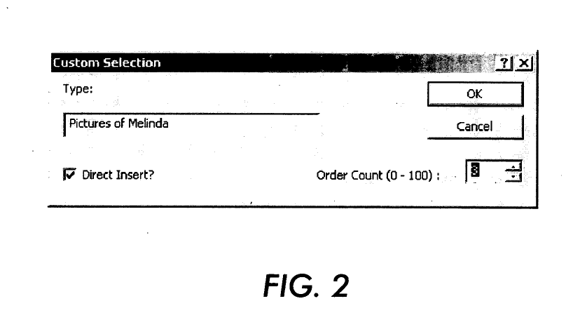

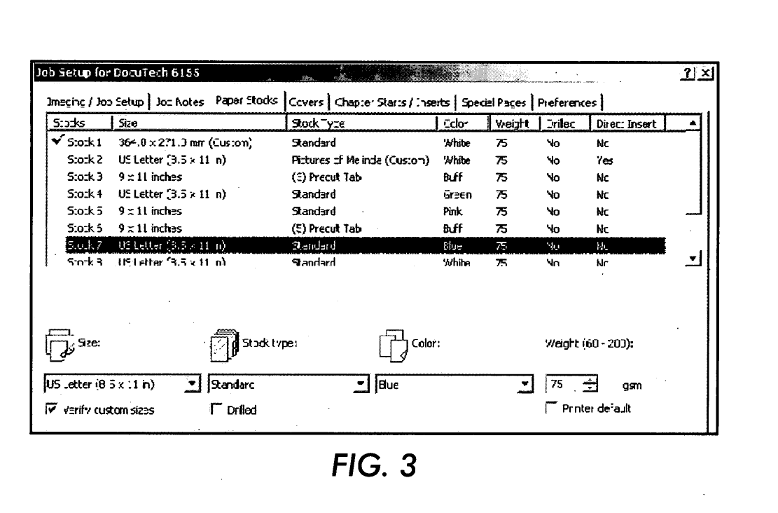

Embodiments herein also include a user interface 120 for guaranteed direct inserts, as shown in screenshots FIGS. 2 and 3. FIG. 2 shows a screen shot of a printer tray setup that includes “Fuser” and Non-fuser” paper stock routes as well as different sizes, colors, weights, etc. of stock. FIG. 3 shows a preprinted stock “Pictures of Melinda (Custom)” and other stocks listed in a dialog displaying their properties. FIG. 3 illustrates a frequent usage of embodiments herein: collation of an ordered set of glossy pictures into a black and white print job. Conflict checking within the printer verifies that printing stocks are only used for printed pages, and direct insert (non-printing) stocks are only used for non-printing covers or direct inserts. Direct insert stocks can always be set up as a type of custom stock. With embodiments herein, errors are avoided because the direct insert flag corresponds to a printer side media attribute that controls the operation/non-operation of the printer.

One cause of the difficulty with direct inserts can be discerned by inspecting the way in which conventional job tickets describe media. During print submission, relevant media parameters are transferred to the printer via the job ticket. For example, a job ticket that specifies paper stock information can be represented in the following manner:

<media-col syntax=“collection”>
<media-size syntax=“collection”>
<x-dimension syntax=“integer”>21600</x-dimension>
<y-dimension syntax=“integer”>27900</y-dimension>
</media-size>
<media-hole-count syntax=“integer”>0</media-hole-count>
<media-color syntax=“keyword”>white</media-color>
<media-type syntax=“keyword”>stationery</media-type>
<media-weight-metric syntax=“integer”>75</media-weight-metric>
</media-col>

Note, that in the above, the paper stock is not designated as a printing or non-printing stock. To the contrary, with embodiments herein, the media attribute disambiguates every paper stock in the job as a printing or non-printing stock. At the printer and in the job ticket, each media will be defined as printing or non-printing (fuser and non-fuser in a xerographic engine). When ajob is submitted for printing, direct insert pages must specify a non-printing stock. Using the representation example listed previously, with embodiments herein, the media definition contains an additional descriptive media attribute:

<media-col syntax=“collection”>
<media-size syntax=“collection”>
<x-dimension syntax=“integer”>21600</x-dimension>
<y-dimension syntax=“integer”>27900</y-dimension>
</media-size>
<media-hole-count syntax=“integer”>0<media-hole-count>
<media-route=“keyword”>non-fuser</media-route>
<media-color syntax=“keyword”>white</media-color>
<media-type syntax=“keyword”>stationery</media-type>
<media-weight-metric syntax=“integer”>75</media-weight-metric>
</media-col>

With this change, the printer itself can validate the state of the paper tray against the stock description in the job ticket. This validation enables the operator to avoid all of the serious complications with direct inserts discussed above. This does not prevent operators from making mistakes, but instead changes the error recovery from a long, expensive procedure to a trivial one. With embodiments herein, when the job ticket does not match the media being call for, the job does not print. Then, the operator checks the job for errors, notices his mistake, and corrects it, without destroying the direct inserts or fuser.

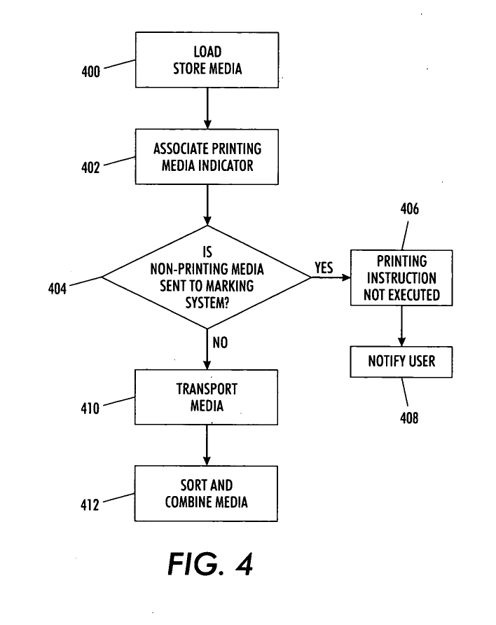

FIG. 4 is a flowchart that illustrates a method embodiment of operating a printing system. In FIG. 4, the flow begins with item 400 where one or more types of media are stored in each of the storage units. In item 402, the operator associates a non-printing media route information with one or more corresponding storage units when printing media that should avoid the marking system is loaded into the corresponding storage units. Thus, the process in 402 comprises user interaction through a user interface that is used as the printing media is loaded into the storage units.

The printing instructions include printing media route information indicating whether the printing media will be directed to the marking system. The decision box 404 determines if the printing instructions direct printing media into the marking system from one or more of the storage units with which the non-printing media route information is associated. More specifically, in item 404 the printing instructions are compared with the non-printing media route information to determine whether the printing instructions direct the printing media into the marking system from one or more of the storage units with which the non-printing media route information is associated. If so, in item 406, the printing instruction is not executed and, in item 408, the embodiments herein indicate, through the user interface, that the printing instructions were not executed because of an inconsistency between the non-printing media route information and printing media route information requiring that the printing media be directed to the marking system.

Otherwise, in item 410, the printing media is transported from the storage units to either the marking system or a bypass path around the marking system. The bypass path transports the printing media around the marking system such that the printing media avoids the marking system. In item 412, the sheets of the printing media that are output from the marking system and from the bypass path are sorted and combined.

Thus, embodiments here provide, among other features, a new paper stock attribute adapted to distinguish between printing and non-printing stocks. Only printing stocks (determined according to the attribute) can be sent through the marking device and non-printing stocks (again, determined according to the attribute) must bypass the marking device. With the embodiments described herein, there is no printer down time due to operator errors, no loss of paper, including preprinted (direct insert) stock, and quick recovery from incorrect printer configuration. Thus, the embodiments herein enable customers to use direct inserts without human errors causing serious disruption of the print shop.

While the foregoing has been described in conjunction with various exemplary embodiments, it is to be understood that many alternatives, modifications and variations would be apparent to those skilled in the art. Accordingly, Applicants intend to embrace all such alternatives, modifications and variations that follow in this spirit and scope.

What is claimed is:

1. A method comprising:
storing at least one type of printing media in each of a plurality of storage units of a printing system;
associating non-printing media route information with one or more corresponding storage units when printing media that should avoid a marking system of said printing system is loaded into said one or more corresponding storage units; and
preventing printing instructions from being executed that direct said printing media into said marking system from one or more of said storage units with which said non-printing media route information is associated.

2. The method according to claim 1, wherein said associating of said non-printing media route information with said one or more corresponding storage units comprises user interaction through a user interface that is used as said printing media is loaded into said storage units.

3. The method according to claim 1, wherein said process of preventing said printing instructions from being executed comprises comparing said printing instructions with said non-printing media route information to determine whether said printing instructions direct said printing media into said marking system from one or more of said storage units with which said non-printing media route information is associated.

4. The method according to claim 1, further comprising transporting said printing media from said storage units to one of said marking system and a bypass path around said marking system.

5. The method according to claim 1, wherein said printing instructions include printing media route information indicating whether said printing media will be directed to said marking system.

6. The method according to claim 1, wherein said printing media that should avoid said marking system may damage said marking system and may be damaged by said marking system.

7. The method according to claim 1, further comprising indicating, through a user interface, that said printing instructions were not executed relating to an inconsistency between said non-printing media route information and printing media route information requiring that said printing media be directed to said marking system.

8. A method comprising:
storing at least one type of printing media in each of a plurality of storage units of a printing system;
associating non-printing media route information with one or more corresponding storage units when printing media that should avoid a marking system of said printing system is loaded into said one or more corresponding storage units;
preventing printing instructions from being executed that direct said printing media into said marking system from one or more of said storage units with which said non-printing media route information is associated;
transporting said printing media from said storage units to one of said marking system and a bypass path around said marking system; and
combining sheets of said printing media that are output from said marking system and from said bypass path.

9. The method according to claim 8, wherein said associating of said non-printing media route information with said one or more corresponding storage units comprises user interaction through a user interface that is used as said printing media is loaded into said storage units.

10. The method according to claim 8, wherein said process of preventing said printing instructions from being executed comprises comparing said printing instructions with said non-printing media route information to determine whether said printing instructions direct said printing media into said marking system from one or more of said storage units with which said non-printing media route information is associated.

11. The method according to claim 8, wherein said bypass path transports said printing media around said marking system such that said printing media avoids said marking system.

12. The method according to claim 8, wherein said printing instructions include printing media route information indicating whether said printing media will be directed to said marking system.

13. The method according to claim 8, wherein said printing media that should avoid said marking system may damage said marking system and may be damaged by said marking system.

14. The method according to claim 8, further comprising indicating, through a user interface, that said printing instructions were not executed relating to an inconsistency between said non-printing media route information and printing media route information requiring that said printing media be directed to said marking system.

15. A printing system comprising:
a plurality of storage units adapted to store printing media;
a marking system adapted to print on said printing media;
a bypass path adjacent said marking system;
a controller adapted to direct said printing media from said storage units into one of said marking system and said bypass path; and
a memory device connected to said controller, wherein said memory device is adapted to associate non-printing media route information with one or more corresponding storage units when printing media that should avoid said marking system is loaded into said one or more corresponding storage units,
wherein said controller prevents printing instructions from being executed that direct said printing media into said marking system from one or more of said storage units with which said non-printing media route information is associated in said memory device.

16. The printing system according to claim 15, further comprising a user interface adapted to associate said non-printing media route information with one or more corresponding storage units as said printing media is loaded into said storage units.

17. The printing system according to claim 15, wherein said controller includes a comparator adapted to compare said printing instructions with said non-printing media route information in said memory device to determine whether said printing instructions direct said printing media into said marking system from one or more of said storage units with which said non-printing media route information is associated.

18. The printing system according to claim 15, wherein said bypass path transports said printing media around said marking system such that said printing media avoids said marking system.

19. The printing system according to claim 15, wherein said printing instructions include printing media route information indicating whether said printing media will be directed to said marking system.

20. The printing system according to claim 15, wherein said printing media that should avoid said marking system may damage said marking system and may be damaged by said marking system.

21. The printing system according to claim 15, further comprising a user interface adapted to indicate to a user that said printing instructions were not executed relating to an inconsistency between said non-printing media route information and printing media route information requiring that said printing media be directed to said marking system.

22. A printing system comprising:
a plurality of storage units, each being adapted to store at least one type of printing media;
a transportation system adjacent said storage units;
a marking system adjacent said transportation system, wherein said marking system is adapted to print on said printing media;
a bypass path adjacent said transportation system, wherein said transportation system is adapted to transport said printing media from said storage units to one of said marking system and said bypass path;
a controller connected to said transportation system, wherein said controller directs said printing media into one of said marking system and said bypass path;
a sorter adapted to combine sheets of said printing media that are output from said marking system and from said bypass path; and
a memory device connected to said controller, wherein said memory device is adapted to associate non-printing media route information with one or more corresponding storage units when printing media that should avoid said marking system is loaded into said one or more corresponding storage units,
wherein said controller prevents printing instructions from being executed that direct said printing media into said marking system from one or more of said storage units with which said non-printing media route information is associated in said memory device.

23. The printing system according to claim 22, further comprising a user interface adapted to associate said non-printing media route information with one or more corresponding storage units as said printing media is loaded into said storage units.

24. The printing system according to claim 22, wherein said controller includes a comparator adapted to compare said printing instructions with said non-printing media route information in said memory device to determine whether said printing instructions direct said printing media into said marking system from one or more of said storage units with which said non-printing media route information is associated.

25. The printing system according to claim 22, wherein said bypass path transports said printing media around said marking system such that said printing media avoids said marking system.

26. The printing system according to claim 22, wherein said printing instructions include printing media route information indicating whether said printing media will be directed to said marking system.

27. The printing system according to claim 22, wherein said printing media that should avoid said marking system may damage said marking system and may be damaged by said marking system.

28. The printing system according to claim 22, further comprising a user interface adapted to indicate to a user that said printing instructions were not executed relating to an inconsistency between said non-printing media route information and printing media route information requiring that said printing media be directed to said marking system.
